(19) United States
(12) Patent Application Publication
(10) Pub. No.: US 2014/0365225 A1
(43) Pub. Date: Dec. 11, 2014

(54) ULTRA-LOW-POWER ADAPTIVE, USER INDEPENDENT, VOICE TRIGGERING SCHEMES

(71) Applicant: DSP Group, San Jose, CA (US)

(72) Inventor: Moshe Haiut, Ramat-Gan (IL)

(73) Assignee: DSP Group, San Jose, CA (US)

(21) Appl. No.: 14/155,045

(22) Filed: Jan. 14, 2014

Related U.S. Application Data
(60) Provisional application No. 61/831,204, filed on Jun. 5, 2013.

(51) Int. Cl. G10L 15/22

(52) U.S. Cl. CPC G10L 15/22
USPC 704/275

(57) ABSTRACT

Methods and systems are provided for ultra-low-power adaptive, user independent, voice triggering in electronic devices. A voice trigger, which may be configured as ultra-low-power function, may be run in an electronic device, when the electronic device transitions to a power-saving state, and may be used to control the electronic device based on audio inputs. The controlling may comprise capturing an audio input, and processing the audio input to determine when the audio input corresponds to a triggering command, to trigger transitioning of the electronic device from the power-saving state. The processing of audio input, to determine that it corresponds to the triggering command, may be based on use of an adaptively configured state machine. The state machine may be based on a Hidden Markov Model (HMM), and may be configured as a two-dimensional state machine that comprises plurality of lines of incantations, each of which corresponding to the triggering command.

### CLAIM OF PRIORITY

This patent application makes reference to, claims priority to and claims benefit from the U.S. Provisional Patent Application No. 61/831,204, filed on Jun. 5, 2013, which is hereby incorporated herein by reference in its entirety.

### TECHNICAL FIELD

Aspects of the present application relate to electronic devices and audio processing therein. More specifically, certain implementations of the present disclosure relate to ultra-low-power adaptive, user independent, voice triggering schemes, and use thereof in electronic devices.

### BACKGROUND

Various types of electronic devices are available nowadays. For example, electronic devices may be hand-held and mobile, may support communication—e.g., wired and/or wireless communication, and may be general or special purpose devices. In many instances, electronic devices are utilized by one or more users, for various purposes, personal or otherwise (e.g., business). Examples of electronic devices include computers, laptops, mobile phones (including smartphones), tablets, dedicated media devices (recorders, players, etc.), and the like. In some instances, power consumption may be managed in electronic devices, such as by use of low-power modes in which power consumption may be reduced. The electronic devices may transition from such low-power modes when needed. In some instances, electronic devices may support input and/or output of audio (e.g., using suitable audio input/output components, such as speakers and microphones).

Existing methods and systems for managing audio input/output operations and/or power consumption in electronic devices may be inefficient and/or costly. Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for ultra-low-power adaptive, user independent, voice triggering schemes, substantially as shown in and/or described in connection with at least one of the figures, as set forth more completely in the claims.

These and other advantages, aspects and novel features of the present disclosure, as well as details of illustrated implementation(s) thereof, will be more fully understood from the following description and drawings.

### BRIEF DESCRIPTION OF THE DRAWINGS

FIG. 1 illustrates an example system that may support use of adaptive ultra-low-power voice triggers.

FIG. 2 illustrates an example two-dimensional HMM state machine, which may be used in controlling processing of a triggering phrase.

FIG. 3 illustrates an example use of state machines during automatic training and adaptation, for use in ultra-low-power voice trigger.

FIG. 4 is a flowchart illustrating an example process for utilizing adaptive ultra-low-power voice triggering.

FIG. 5 is a flowchart illustrating an example process for adaption of a triggering phrase.

### DETAILED DESCRIPTION

Certain example implementations may be found in method and system for ultra-low-power adaptive, user independent, voice triggering schemes in electronic devices, particularly in handheld or otherwise user-supported devices. As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first plurality of lines of code and may comprise a second “circuit” when executing a second plurality of lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “example” means serving as a non-limiting example, instance, or illustration. As utilized herein, the terms “for example” and “e.g.,” introduce a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

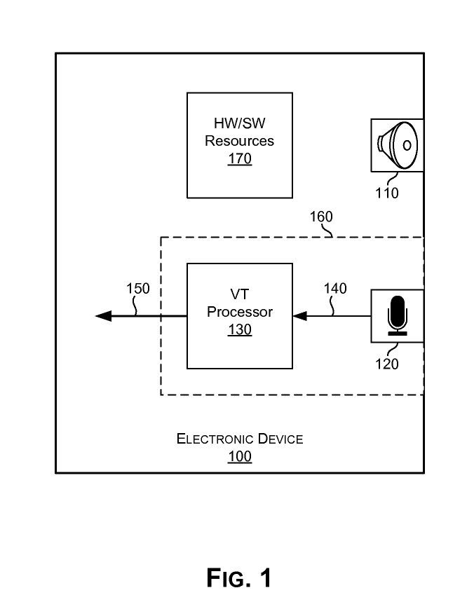

FIG. 1 illustrates an example electronic device that may support use of adaptive ultra-low-power voice triggers. Referring to FIG. 1, there is shown an electronic device 100.

The electronic device 100 may comprise suitable circuitry for performing or supporting various functions, operations, applications, and/or services. The functions, operations, applications, and/or services performed or supported by the electronic device 100 may be run or controlled based on user instructions and/or pre-configured instructions.

In some instances, the electronic device 100 may support communication of data, such as via wired and/or wireless connections, in accordance with one or more supported wireless and/or wired protocols or standards.

In some instances, the electronic device 100 may be mobile and/or handheld device—i.e. intended to be held or otherwise supported by a user during use of the device, thus allowing for use of the device on the move and/or at different locations. In this regard, the electronic device 100 may be designed and/or configured to allow for ease of movement, such as to allow it to be readily moved while being held or supported by the user as the user moves, and the electronic device 100 may be configured to perform at least some of the operations, functions, applications and/or services supported by the device on the move.

The electronic device 100 may support input and/or output of audio. The electronic device 100 may incorporate, for example, a plurality of speakers and microphones, for use in outputting and/or inputting (capturing) audio, along with suitable circuitry for driving, controlling and/or utilizing the speakers and microphones. As shown in FIG. 1, for example, the electronic device 100 may comprise a speaker 110 and a microphone 120 and 130. The speaker 110 may be used in outputting audio (or other acoustic) signals from the electronic device 100; whereas the microphone 120 may be used in inputting (e.g., capturing) audio or other acoustic signals into the electronic device 100.

Examples of electronic devices may comprise communication mobile devices (e.g., cellular phones, smartphones, and tablets), computers (e.g., servers, desktops, and laptops), dedicated media devices (e.g., televisions, portable media players, cameras, and game consoles), and the like. In some instances, the electronic device 100 may even be a wearable device—i.e., may be worn by the device's user rather than being held in the user's hands. Examples of wearable electronic devices may comprise digital watches and watch-like devices (e.g., iWatch) or glasses (e.g., Google Glass). The disclosure, however, is not limited to any particular type of electronic device.

In some instances, the electronic device 100 may be configured to enhance power consumption. Enhancing power consumption may be desirable, such as where electronic devices incorporate (and draw power from) internal power supply components (e.g., batteries), particularly when external power supply (e.g., connectivity to external power sources, such as electrical outlets) may not be possible. In such scenarios, optimizing power consumption may be desirable to reduce depletion rate of the internal power supply components, thus prolonging time that the electronic device may continue to run before recharge.

Enhancing power consumption may be done by use of, for example, different modes of operation, with at least some of these modes of operation providing at least some power saving compared with full operational mode. For example, in its simplest form, an electronic device (e.g., the electronic device 100) may incorporate use of a power consumption scheme comprising a fully operational ‘active’ mode, in which all resources (hardware and/or software) 170 in the device may be active and running, and a ‘sleep’ mode, in which at least some of the resources may be shut down or deactivated, to save power. Thus, when the electronic device transitions to ‘sleep’ mode, the power consumption of the device may be reduced. The use of such reduced-power-consumption states may be beneficial in order to save internal power supply components (e.g., battery power) and/or may be required by various standards in order to restrict consumption of network or global energy.

The electronic device may incorporate various mechanisms for enabling and/or controlling transitioning the device to and/or back from such low-power states or modes. For example, the electronic device 100 may be configured such that a device user may be expected to press a button in order to wake-up the device from ‘sleep’ mode and return it to fully operational ‘active’ mode. Such transitioning mechanisms, however, may require maintaining active in the low-power states (e.g., ‘sleep’ modes) certain resources that require considerable power consumption, thus reducing the amount of power saved. In the example described above (i.e., button-pressing based approach), components used in enabling detection of such actions by the user, processing the user interactions, and making a determination based thereon may be necessary.

Accordingly, in various implementations of the present disclosure, improved, more power-efficient and user friendly mechanisms may be used (and particularly configured, ultra-low-power resources for supporting such approaches may be used). For example, a more user friendly method for enabling such transitioning may be by means of audio input—e.g., for the user to utter a pre-determined phrase in order to transition the device from low-power (e.g., ‘sleep’) modes to active (e.g., ‘full-operation’) modes.

For example, electronic devices may be configured to support use of Automatic Speech Recognition (ASR) technology as a means for entering voice commands and control phrases. Device users may, for example, operate Internet browsers on their smartphones or tablets by speaking audio commands. In order to respond to the user command or request, the electronic device may incorporate ASR engines. Such ASR engines, however, may typically require significant power consumption, and as such keeping them always active including in low-power states (for voice triggering the device to wake up from a sleeping mode) may not be desirable. Accordingly, an enhanced approach may comprise use of ultra-low-power voice trigger (VT) speech recognition scheme, which may be configured to wake-up a device when a user speaks pre-determined voice command(s). Such VT speech recognition scheme may differ from existing, conventional ASR solutions in that it may be limited in power consumption and computing requirements, such that it may meet the requirement of still being active when the device is in low-power (e.g., ‘sleep’) modes.

For example, the VT speech recognition scheme may only be required to recognize one or more short, specific phrases in order to trigger the device wake-up sequence. Furthermore, the VT speech recognition scheme may be configured to be ‘user independent’ such that it may be adapted to different users and/or different sound conditions (including when used by the same user). Conventional ASR solutions may generally require a relatively big database in order to operate, even when only required to recognize a single phrase, and it is difficult to reduce their power consumption to ultra-low levels. Further, existing solutions may be either user dependent or user independent. A common disadvantage of a user independent approach is that it is generally limited to using a single, fixed, pre-determined phrase for triggering, and the pre-determined phrase would trigger regardless of the identity of the speaker. User dependent SR solutions require smaller data bases but have the disadvantage of requiring a training procedure where the user is asked to run the application for the first time in a specially selected ‘training mode’ and repeat a phrase several times in order to enable the application to adapt to and learn the user's speech. The VT speech recognition scheme utilized in the present disclosure, however, may incorporate elements of both approaches, for optimal performance. For example, the VT speech recognition scheme may be initially configured to recognize a pre-defined phrase (e.g., set by device manufacturer), and the VT speech recognition scheme may allow for some adaptive increase in number of users and/or phrases in an optimal manner, to ensure that the VT speech recognition scheme be limited to generating, maintaining, and/or using a small database in order to consume ultra-low-power.

Accordingly, the VT speech recognition scheme may be implemented by use of only limited components in low-power modes. For example, the electronic device 100 may incorporate a VT component 160, which may only comprise the microphone 120 and VT processor 130. VT processor 130 may comprise circuitry that may be configured to provide only the processing (and/or storage) required for implementing the VT speech recognition scheme. Thus, the VT processor 130 may be limited to only processing audio (to determine a match with pre-configured voice triggering commands and/or match with authorized users) and/or to store the small database needed for VT operations. The VT processor 130 may comprise a dedicated resource (i.e., distinct from remaining resources 170 in the electronic device). Alternatively, the VT processor 130 may correspond to a portion of existing resources, which may be configured to support (only) VT operations, particularly in low-power states.

In some instances, the VT speech recognition scheme implemented via the VT component 160 may be configured to use special algorithms, such as for enabling automatic adaption of particular voice triggering commands and/or particular users. Use of such algorithms may enable the VT speech recognition scheme to automatically widen its database, to improve the recognition hit rate of the user upon any successful or almost successful recognition. For example, the VT component 160 may be configured to incorporate adaption algorithms based on the Hidden Markov Model (HMM). Thus, the VT component 160 may become a ‘learning’ device, enhancing user experience due to improved VT hit rate (e.g., improving significantly after two or three successful or almost successful recognitions). For example, traditional user independent speech recognition schemes may be based on distinguishing between syllables and recognizing each syllable, and then recognizing the phrase from the series of syllables. Further, both of these stages may be performed based on statistical patterns. As a result, traditional approaches usually require significant amount of computing and/or power consumption (e.g., complex software, and related processing/storage needed to running thereof). Therefore, such traditional approaches may not be applicable or suitable for VT solutions. Accordingly, the VT speech recognition scheme (e.g., as implemented by the VT component 160) may incorporate use of enhanced, more power-efficient approach, such as based on user dependent HMM state-machines, which may be two dimensional (i.e., a ‘two-dimensional HMM’) state-machines.

In this regard, conventional approaches to speech recognition are typically implemented based on statistics. Thus a phrase (or portions thereof) may only be matched one way based on existing statistics. On the other hand, with VT speech recognition scheme in accordance with the present disclosure, two-dimensional HMM state-machines are used, and configured such that they may comprise different states, which may be produced from representatives of feature extraction vectors that are taken from the input phrase in real time—i.e., with multiple states corresponding to the same phrase (or portions thereof). Further, the states may be arranged in lines (i.e., different sequences may correspond to the same phrase). The phrases may not be necessarily synchronized with the syllables. New states may be produced when a new vector differs significantly from the originating vector of the current state. Thus, every repetition of the training phrase produces an independent line of HMM states in the two-dimensional HMM state machine and the “statistics” may be replaced by having several lines rather than a single line. As a result, the final database, as adapted, may comprise multiple (e.g., 3-4) lines of HMM states.

Therefore, when handling a phrase, both horizontal and vertical transitions may be used between states. Further, sometimes specific parts of the phrase would better match the database from different lines, and by utilizing this feature, the hit rate can be dramatically improved. Conversely a “statistics” based line would have to represent multiple vertical states in every single state, hence it is less efficient. The use of these multi-line HMM state machines may allow for addition of new lines in real-time, as the feature-extraction vector may be computed anyway during the recognition stage. Accordingly, the VT speech recognition scheme (and processing performed during VT operations), using such two-dimensional HMM state machines, may be optimized since it is based on combination of an initial fixed database coupled with a learning algorithm. The fixed database is the set of one of more pre-determined VT phrases that are pre-stored (e.g., into the VT processor 130). The fixed database may enable the generation of feedback to the learning process, so that the user does not have to initiate the device with a training sequence. Accordingly, the VT speech recognition scheme used herein may retain the capability to cater for new user conditions and the ability to adapt quickly if conditions change. For example, if a new user replaces the old user of the device, the device may adapt to the new user after few VT component 160 attempts rather than be locked forever on the previous user. An example of two-dimensional HMM state machines and use thereof is described in more detail with respect to some of the following figures.

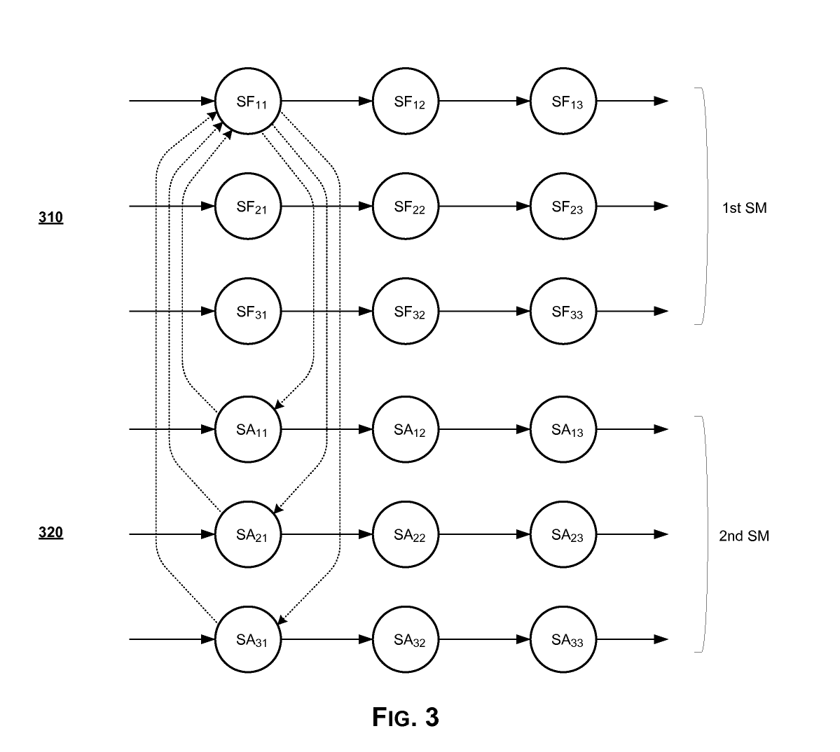

In some implementations, electronic device incorporating voice triggering implemented in accordance with the present disclosure may be configured to support recognizing (and using) more than a single triggering phrase (e.g., support multiple pre-defined triggering phrases), and/or to produce a triggering output that may comprise information about which one of the multiple pre-defined triggering phrases is detected. Further, in addition to using triggering phrases to simply turning on or activating (waking up) the device, additional triggering phrases may be used to trigger particular actions once the device is turned on and/or is activated. Accordingly, the voice triggering scheme described in the present disclosure may also be used to allow for enhanced voice triggering even while the device is active (i.e. awake). For example, the electronic device 100 may be configured (e.g., by configuring the VT processor 130) to support three different pre-defined phrases, such as configuring (in the VT processor 130) three different groups of HMM states lines. In this regard, each of the three groups may comprise a section of fixed lines and a section of adaptive lines, as described in more detail in the following figures (e.g., FIG. 3). Further, each one of the three groups may be dedicated to a specific one of the three pre-defined phrases. Thus, when an audio input is detected (e.g., via the microphone 120), the electronic device 100 may as part of the voice triggering based processing, search for a match with any one of the three pre-defined phrases, using the three groups of HMM state lines. For example, the pre-defined phrases may be: “Turn-on”, “Show unread messages”, and “Show battery state”.

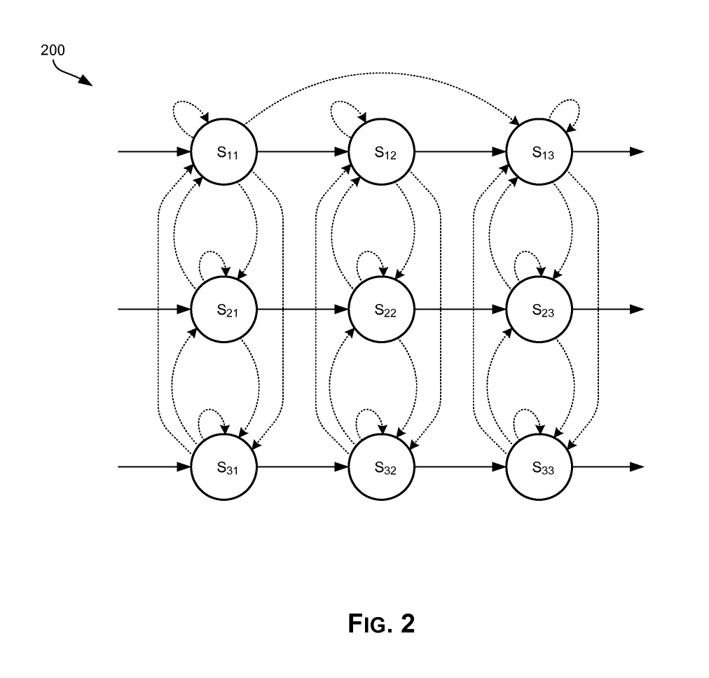

FIG. 2 illustrates an example two-dimensional HMM state machine, which may be used in controlling processing of a triggering phrase. Referring to FIG. 2, there is shown a two-dimensional HMM state machine 200.

The two-dimensional HMM state machine 200 may correspond to a particular phrase, which may be used for processing phrases to determine if they correspond to preset voice triggering commands. For example, the two-dimensional HMM state machine 200 may be utilized during processing in the VT processor 130 of FIG. 1. Accordingly, the VT processor 130 may be configured to process possible triggering phrases that may be captured via the microphone 120, by using two-dimensional HMM state machine 200 to determine if the captured phrase is recognized as one of preset triggering phrases. The state machine 200 may be ‘two-dimensional’ in that the HMM states may relate to multiple incantations of a single phrase—i.e. the same phrase, spoken by different speakers and/or under different condition (e.g., different environmental noise). A two-dimensional HMM state machine that is configured based on several incantations of the same phrase (as is the case with state machine shown in FIG. 2) may behave as a user independent speech recognition device and can recognize if the phrase corresponds to a preset phrase used for voice triggering.

In the example shown in FIG. 2, the two-dimensional HMM state machine 200 may be 3×3 state machine—comprising 9 states: states S₁₁, S₁₂, and S₁₃ may relate to the first incantation of the phrase; states S₂₁, S₂₂, and S₂₃ may relate to a second incantation of the phrase; and states S₃₁, S₃₂, and S₃₃ may relate to a third incantation of the phrase. While the HMM state machine shown in FIG. 1 has 3 lines (i.e., 3 incantations), with each line comprising 3 states (i.e., the phrase comprising 3 parts), the disclosure is not so limited. For example, further incantations may be utilized—e.g., would be similarly represented by Sₓ₁, Sₓ₂, and Sₓ₃ where x increments with each incantation. A successful recognition of a phrase may occur, in accordance with the state machine 200, when processing the phrase may result in traversal of the state machine from start to end (i.e., left to right). This may entail jumping from one state to another until reaching one of the end states in one of the lines (i.e., one of states S₁₃, S₂₃, and S₃₃). The jumps (shown as arrowed dashed lines) between the states may be configured adaptively to represent ‘transition probabilities’ between the states. Accordingly, the recognition probability for a particular phrase may be determined based on a product of probabilities of all state transitions undertaken during processing the phrase.

The HMM state machine 200 may be configured to allow switching between two or more different incantations of the phrase during the recognition process (stage) while moving forward along the phrase sequence. For example, in the two-dimensional model shown in FIG. 2, the state S₁₁ can be followed by state S₁₂ or directly by state S₁₃ to move forward in the phrase sequence in the horizontal axis, staying on the same phrase incantation. However, it may also be possible to jump from state S₁₁ to state S₂₁ or state S₃₁ to switch between incantations. Other possible transitions from state S₁₁ (although not shown) may be directly to state S₂₂, S₂₃, S₃₂, or even S₃₃.

FIG. 3 illustrates an example use of state machines during automatic training and adaptation, for use in ultra-low-power voice trigger. Referring to FIG. 3, there is shown HMM state machine matrix, comprising two instances 310 and 320 of two-dimensional HMM state machine.

Each of the HMM state machines 310 and 320 may be substantially similar to the HMM state machine 200 of FIG. 2, for example. Nonetheless, the HMM state machines 310 and 320 may be used for different purposes. For example, the HMM state machine 310 may correspond to pre-defined fixed incantations, whereas the HMM state machine 320 may correspond to adaption incantations. In this regard, the HMM architecture shown in FIG. 3 may contain lines of fixed incantations (the lines of the state machine 310), which may be optimized incantations of a pre-defined phrase which may be pre-programmed into the system; as well as lines of incantations that are intended for field adaptation. For example, each of the two-dimensional HMM state machines 310 and 320 may be configured as a 3×3 state machine—e.g., each of the state machines 310 and 320 may comprise 9 states. In this regard, states SF₁₁, SF₁₂, and SF₁₃ in state machine 310 and states SA₁₁, SA₁₂, and SA₁₃ in state machine 320 may relate to the first incantations (fixed and adaptation) of the phrase; states SF₂₁, SF₂₂, and SF₂₃ in state machine 310 and states SA₂₁, SA₂₂, and SA₂₃ in state machine 320 may relate to a second incantations (fixed and adaptation) of the phrase; and states SF₃₁, SF₃₂, and SF₃₃ in state machine 310 and states SA₃₁, SA₃₂, and SA₃₃ in state machine 320 may relate to the third incantations (fixed and adaptation) of the phrase. Nonetheless, while the HMM state machines shown in FIG. 2 are shown as having 3 lines (i.e., 3 incantations), with each line comprising 3 states (i.e., the phrase comprising 3 parts), the disclosure is not so limited. As with the state machine 200, processing a phrase (for recognition) may entail transitions between the states. In this regard, as with the state machine 200, each transition may have associated therewith a corresponding ‘transition probability’. Further, in the HMM state machine matrix of FIG. 3 (comprising the two state machines, corresponding to fixed and adaptation incantations), transitions between states in different ones of the two states machines may be possible. In this regard, transitions may be possible from any of the 18 states (in both state machines), to any of the remaining 17 states in a HMM state machine matrix. For example, as shown in FIG. 1, transitions may be possible from state SF₁₁ in state machine 310 to each of states SA₁₁, SA₁₂, and SA₁₃ in state machine 320. Nonetheless, some of these transitions may not be truly possible (e.g., transitioning to earlier states, such as from state SF₁₂ to any one of states SFᵢ₁ in state machine 310 or states SAᵢ₁ in state machine 320). Nonetheless, this may be accounted for by assigning appropriate corresponding ‘transition probabilities’.

The lines of field adaptation incantations (i.e., lines of state machine 320) may be initially empty, so that recognition of the pre-defined phrase may be based (only) on the fixed incantations lines (i.e., lines of state machine 310) when the algorithm is run for the first time. The initial setting may not be optimized for a specific user, and as such marginal recognition metrics may be expected to be common in the first voice-triggering attempts. In this regard, a marginal recognition metric may result in an almost successful recognition or an almost ‘failed to recognize’ decision. The optimized scheme (and architectures corresponding thereto—e.g., the architecture shown in FIG. 3) may take advantage of such marginal decisions—e.g., by using them as indications to determine voice triggering attempts. Having a particular number (e.g., ‘N’) of concurrent marginal failure decisions occurring within a particular time frame (e.g., ‘T’ seconds) may be used to indicate clearly unsuccessful VT attempts from the user.

For example, for N=2 and T=5, new HMM incantation lines may be added when two successive marginal decisions occur within a time period of 5 seconds. Based on detection of these conditions, the adaptive VT algorithm will distinguish between random speech and speech that was intended for voice triggering, and will only adapt to the VT speech, in real time, in order to capture and calculate the new incantation lines and add them to the HMM architecture (in the HMM state machine 320, corresponding to lines of adaptation incantations). In other words, when this occurs for the first time, the new line of states is stored into one of the field adaptation instantiations in the state machine 320. From this point onwards the user may be expected to experience a significant improvement in the VT recognition hit rate, as the user's unique speech model may then be included in the two-dimensional HMM database. Accordingly, use of the two state machines, and particularly support for adaption incantation, may allow for adding additional lines to the field adaptation instantiations area of the HMM database due to, for example, new conditions of environmental noise—e.g., in instances where a user may be making a VT attempt while traveling in train or car, with different background noise affecting the speech.

When no empty lines in the field adaptation area remain, old lines may be overridden in certain situations (e.g., in similar manner similar to cache-memory management). For example, the VT algorithm may be configured to produce a histogram of the recent usage rate of each one of the HMM states but only in the field adaptation HMM state machine 320. In this regard, the histogram may be used to decide which HMM line to override, or if a new line of states should be added to the HMM matrix. The VT algorithm may take into account the accumulated percentage of usage of each existing line, as well as other factors (e.g., aging factor—i.e., lines that were added to the HMM matrix and not used for a long time may be identified as candidates to be replaced by new lines). In other words, the decision (to replace a line) may be based on how popular each line is, and lines with states that were not in use for a long time are therefore candidates to be re-written.

The use of such lines (ones that have not been used in extended period of time) may be desirable as these lines would be, for example, associated with a previous user, or to the same user but with an environmental condition that is no longer (or is rarely) applicable. For example, the would-be-replaced line may have been automatically created when two marginally successful recognitions occurred while the user passed near a machine with a specific noise.

The lines of fixed incantations—i.e., the lines stored in the state machine portion 310—may be pre-programmed (e.g., into the circuitry of the VT processor 130), and would remain un-touched by the algorithm. Accordingly, the VT algorithm (and thus the processing performed by the VT processor) may retain the original minimum adaption capability to cater for new VT conditions. For example, if a new user replaces the old user of the device, the device will adapt to the new user after a few VT attempts rather than be locked forever on the previous user.

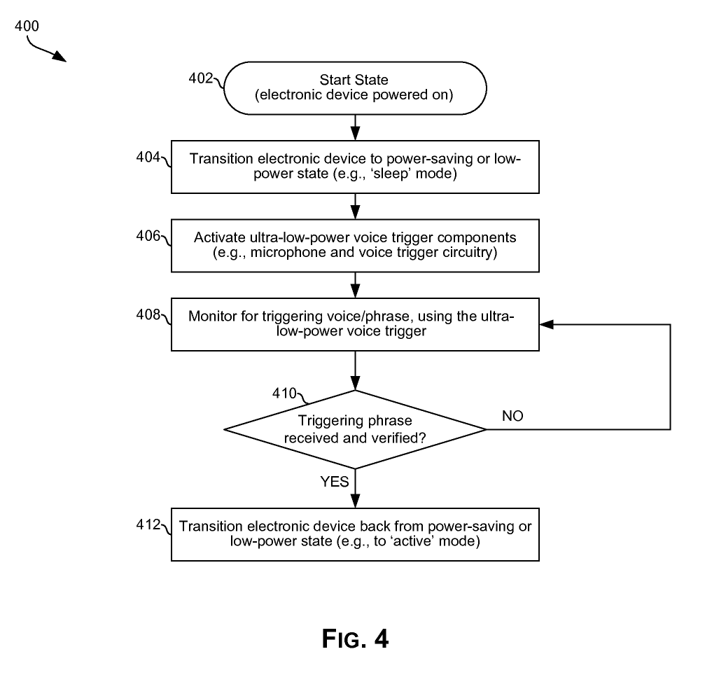

FIG. 4 is a flowchart illustrating an example process for utilizing adaptive ultra-low-power voice triggering. Referring to FIG. 4, there is shown a flow chart 400, comprising a plurality of example steps, which may be executed in a system (e.g., the electronic device 100 of FIG. 1), to facilitate ultra-low-power voice triggering.

In a starting step 402, an electronic device (e.g., the electronic device 100) may be powered on. Powering on the electronic device may comprise powering, initializing, and/or running various resources in the electronic device (e.g., processing, storage, etc.).

In step 404, the electronic device may transition to power-saving or low-power state (e.g., ‘sleep’ mode). The transition may be done to reduce power consumption (e.g., where the electronic device is drawing from internal power supplies—such as batteries). The transition may be based on pre-defined criteria (e.g., particular duration of time without activities, battery level, etc.). The transition to the power-saving or low-power states may entail shutting off or deactivating at least some of the resources of the electronic device.

In step 406, ultra-low-power voice trigger components may be configured, activated, and/or run. The ultra-low-power voice trigger components may comprise a microphone and a voice trigger circuitry.

In step 408, the ultra-low-power voice trigger may be utilized in monitoring for triggering voice/commands. In this regard, the triggering voice/command may comprise a particular (preset) phrase, which may have to be spoken only by particular user (i.e., particular voice).

In step 410, the received triggering voice/commands may be verified. The verification may comprise verifying that the captured command matches the preset triggering command. Also, the verification may comprise determining that the voice matches that of an authorized user. In instances where received triggering voice/commands fails verification, the process loops back to step 408, to continue monitoring. Otherwise (i.e., the received triggering voice/commands is successfully verified), the process proceeds to step 412, the electronic device is transitioned from the power-saving or low-power state, such as back to fully active state (thus reactivating or powering on the resources that where shut off or deactivated when the electronic device transitioned to the power-saving or low-power state).

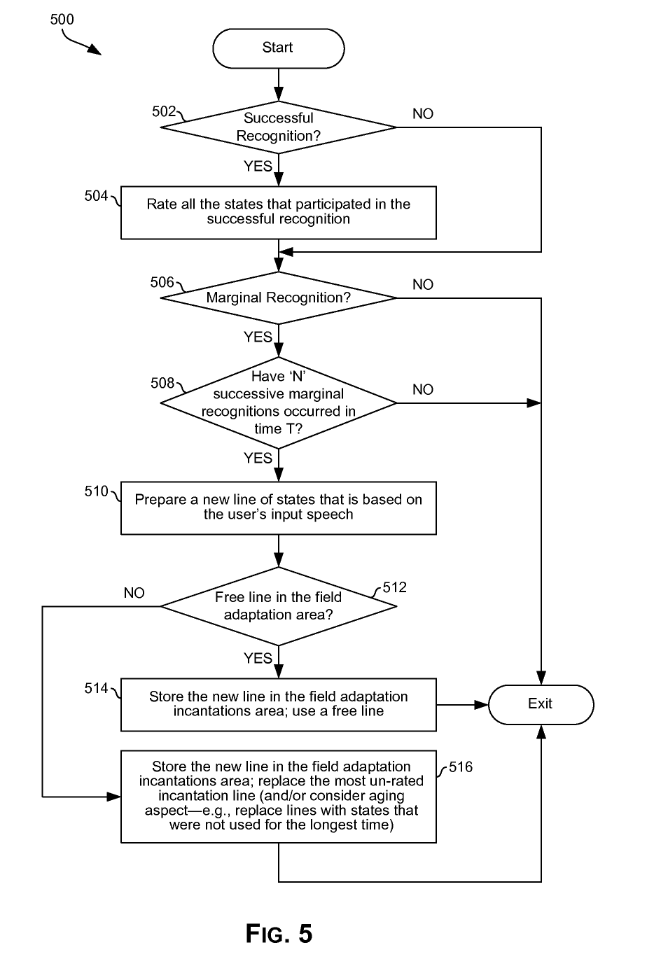

FIG. 5 is a flowchart illustrating an example process for adaption of a triggering phrase. Referring to FIG. 5, there is shown a flow chart 500, comprising a plurality of example steps.

In step 502, after a start step (e.g., corresponding to initiation of the process, such as when a voice-triggering attempt is made), it may be determined if a voice-triggering phrase is recognizable. The determination may be done using a HMM state machine (or matrix comprising fixed and adaption state machines). In instance where it may be determined that there is no successful recognition, the process may jump to step 506; otherwise the process may proceed to step 504.

In step 504, all states that may have participated in the successful recognition (i.e., including states on different lines, where there may have been line-to-line jumps) may be rated. The rating may represent the dependency of the match—i.e., the more reliable a match is, the higher the rating.

In step 506, it may be determined whether the recognition is (or is not) marginal. For example, marginal recognition may correspond to almost successful recognition or an almost ‘failed to recognize’ decision. In instances where the recognition is not marginal, the process may proceed to an exit state (e.g., returning to a main handling routine, which initiated the process due to the voice-triggering attempt).

Returning to step 506, in instances where the recognition is marginal, the process may proceed to step 508. In step 508, the marginal recognition(s) may be evaluated, to determine if they are still sufficiently indicative of success (or failure) of voice triggering, and such may be used to modify the voice triggering algorithm—e.g., to add or replace adaption incantations. For example, it may be determined in step 508 whether there may have been a particular number (e.g., ‘N’) of concurrent marginal decisions (successful or failed attempts) occurring within a particular time frame (e.g., ‘T’ seconds), which may be used to indicate clearly unsuccessful VT attempts from the user. If not, the process may proceed to the exit state; otherwise, the process may proceed to step 510.

In step 510, a new line of states, in the HMM state machine(s), may be set based on the users input speech (which resulted in the sequence of marginal decisions). In step 512, it may be determined if there may be a free line in the field adaptation portion of the state machine matrix (e.g., the state machine 320). If there is a free line available, the process may proceed to step 514. In step 514, the prepared new line may be stored into (one of) the available free line(s) in the field adaptation incantations area (state machine). The process may then proceed to the exit state.

Returning to step 512, in instances where there is no free line available, the process may proceed to step 516. In step 516, the new line may be stored into the field adaptation incantations area (state machine) by replacing one of the lines therein. In this regard, the replaced lined may correspond to the most un-rated (or low rated) incantation line. Further, additional factors may be considered—e.g., age, that is, the replaced line may correspond to the line with the states that have not been used for the longest time. The process may then proceed to the exit state.

In some implementations, a method is utilized for providing ultra-low-power adaptive, user independent, voice triggering schemes in an electronic device (e.g., electronic device 100). The method may comprise: running, when the electronic device transitions to a power-saving state, a voice trigger (e.g., the VT component 160), which is configured as an ultra-low-power function, and which controls the electronic device based on audio inputs. The controlling may comprise capturing an audio input (e.g., via microphone 120); processing the audio input (e.g., via the VT processor 130) to determine when the audio input corresponds to a triggering command; and if the audio input corresponds to a preset triggering command, triggering (e.g., via trigger 150) transitioning of the electronic device from the power-saving state. Determining that the audio input corresponds to the triggering command may be based on an adaptively configured state machine (e.g., HMM state machines 200, 310, and/or 320) which may be implemented by the voice trigger (e.g., the VT processor 130 of the VT component 150). The adaptively configured state machine may be based on a Hidden Markov Model (HMM). Further, the adaptively configured state machine may be configured as a two-dimensional state machine that comprises a plurality of lines of incantations, each of which corresponding to the triggering command. The plurality of lines of incantations may comprise a first subset of one or more lines of fixed incantations (e.g., state machine area 310) and a second subset of adaptation incantations (e.g., state machine area 320). The first subset of one or more lines of fixed incantations is pre-programmed and remains unmodified. The second subset of adaptation incantations may be set and/or modified based on voice triggering attempts. A portion of the second subset of adaptation incantations may be selected for modification, such as based on one or more selection criteria. The selection criteria comprising non-use based parameters (e.g., timing parameters defining ‘aging lines’—i.e., lines that were previously set/added but have not been used for a long time may be identified as candidates to be replaced by new lines). The running of the voice trigger may continue after transitioning from the power-saving state, and the voice trigger may be configured to control the electronic device based on audio inputs. The controlling may comprise comparing captured audio input with a plurality of other triggering commands; and when there is a match between captured audio input and one of the other triggering commands, triggering one or more actions in the electronic devices that are associated with the one of the other triggering commands. Determining when there is a match may be based on a plurality of adaptively configured state machines implemented by the voice trigger, each of which associate with one of the other triggering commands.

In some implementations, a system comprising one or more circuits (e.g., the VT component 150) for use in an electronic device (e.g., electronic device 100) may be used in providing ultra-low-power adaptive, user independent, voice triggering schemes in the electronic device. The one or more circuits may utilize, when the electronic device transitions to a power-saving state, a voice trigger (e.g., the VT component 150, or particularly the VT processor 130 thereof) which is configured as an ultra-low-power function. In this regard, the one or more circuits may be operable to capture an audio input (via microphone 120), and process via the voice trigger (e.g., the VT processor 130 thereof) the audio input to determine when the audio input corresponds to a preset triggering command. If the audio input corresponds to a preset triggering command, the one or more circuits may trigger transitioning of the electronic device from the power-saving state. The one or more circuits may be operable to determine that the audio input corresponds to the triggering command based on an adaptively configured state machine that is implemented by the voice trigger. The adaptively configured state machine may be based on a Hidden Markov Model (HMM). The adaptively configured state machine may be configured as a two-dimensional state machine that comprises a plurality of lines of incantations, each of which corresponding to the triggering command. The plurality of lines of incantations comprises a first subset of one or more lines of fixed incantations and a second subset of adaptation incantations. The first subset of one or more lines of fixed incantations is pre-programmed and remains unmodified. The one or more circuits may be operable to set and/or modify the second subset of adaptation incantations based on voice triggering attempts. The one or more circuits are operable to select a portion of the second subset of adaptation incantations for modification based on one or more selection criteria, the selection criteria comprising non-use based parameters (e.g., timing parameters defining ‘aging lines’—i.e., lines that were previously set/added but have not been used for a long time may be identified as candidates to be replaced by new lines). The one or more circuits may be operable to continue running the voice trigger after transitioning from the power-saving state, and the voice trigger may be configured to control the electronic device based on audio inputs. The controlling may comprise comparing captured audio input with a plurality of other triggering commands; and when there is a match between captured audio input and one of the other triggering commands, triggering one or more actions in the electronic devices that are associated with the one of the other triggering commands. The one or more circuits may be operable to determine when there is match based on a plurality of adaptively configured state machines implemented by the voice trigger, each of which associate with one of the other triggering commands.

In some implementations, a system may be used in providing ultra-low-power adaptive, user independent, voice triggering schemes in electronic devices (e.g., the electronic device 100). The system may comprise a microphone (microphone 120) which is configured to capture audio signals, and a dedicated audio signal processing circuit (e.g., the VT processor 120) that is configured for ultra-low-power consumption. In this regard, the microphone may obtain, when the electronic device is a power-saving state, an audio input, the dedicated audio signal processing circuit may process the audio input, to determine if the audio input corresponds to a preset triggering command; and when the audio input corresponds to the triggering command, the dedicated audio signal processing circuit transitions the electronic device from the power-saving state. The dedicated audio signal processing circuit is configured to determine if the audio input corresponds to a preset triggering command based on an adaptively configured state machine that is implemented by the dedicated audio signal processing circuit. The adaptively configured state machine may be based on a Hidden Markov Model (HMM). The adaptively configured state machine may be configured as two-dimensional state machine that comprises plurality of lines of incantations, each of which corresponding to the preset triggering command.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for ultra-low-power adaptive, user independent, voice triggering schemes.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein. Another typical implementation may comprise an application specific integrated circuit or chip.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form. Accordingly, some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A method, comprising:
in an electronic device:
running, when the electronic device transitions to a power-saving state, a voice trigger, wherein:
the voice trigger is configured as an ultra-low-power function, and
the voice trigger controls the electronic device based on audio inputs, the controlling comprising:
capturing an audio input;
processing the audio input to determine when the audio input corresponds to a triggering command; and
if the audio input corresponds to the triggering command, triggering transitioning of the electronic device from the power-saving state.

2. The method of claim 1, comprising determining that the audio input corresponds to the triggering command based on adaptively configured state machine that is implemented by the voice trigger.

3. The method of claim 2, wherein the adaptively configured state machine is based on a Hidden Markov Model (HMM).

4. The method of claim 2, wherein the adaptively configured state machine is configured as a two-dimensional state machine that comprises a plurality of lines of incantations, each of which corresponding to the triggering command.

5. The method of claim 4, wherein the plurality of lines of incantations comprises a first subset of one or more lines of fixed incantations and a second subset of adaptation incantations.

6. The method of claim 5, wherein the first subset of one or more lines of fixed incantations is pre-programmed and remains unmodified.

7. The method of claim 5, comprising setting and/or modifying the second subset of adaptation incantations based on voice triggering attempts.

8. The method of claim 7, comprising selecting a portion of the second subset of adaptation incantations for modification based on one or more selection criteria, the selection criteria comprising non-use based parameters.

9. The method of claim 1, comprising continuing to run the voice trigger after transitioning from the power-saving state, and wherein the voice trigger is configured to control the electronic device based on audio inputs, the controlling comprising:
comparing captured audio input with a plurality of other triggering commands; and
when there is a match between captured audio input and one of the plurality of other triggering commands, triggering one or more actions in the electronic devices that are associated with the one of the plurality of other triggering commands.

10. The method of claim 9, comprising determining when there is a match based on a plurality of adaptively configured state machines implemented by the voice trigger, each of which associate with one of the plurality of other triggering commands.

11. A system, comprising:
one or more circuits for use in an electronic device having a voice trigger that is configured as an ultra-low-power function, the one or more circuits being operable to, when the electronic device is in a power-saving state:
capture an audio input;
process via the voice trigger, the audio input to determine when the audio input corresponds to a triggering command; and
if the audio input corresponds to the triggering command, trigger transitioning of the electronic device from the power-saving state.

12. The system of claim 11, wherein the one or more circuits are operable to determine that the audio input corresponds to the triggering command based on adaptively configured state machine that is implemented by the voice trigger.

13. The system of claim 12, wherein the adaptively configured state machine is based on a Hidden Markov Model (HMM).

14. The system of claim 12, wherein the adaptively configured state machine is configured as a two-dimensional state machine that comprises a plurality of lines of incantations, each of which corresponding to the triggering command.

15. The system of claim 14, wherein the plurality of lines of incantations comprises a first subset of one or more lines of fixed incantations and a second subset of adaptation incantations.

16. The system of claim 15, wherein the first subset of one or more lines of fixed incantations is pre-programmed and remains unmodified.

17. The system of claim 15, wherein the one or more circuits are operable to set and/or modify the second subset of adaptation incantations based on voice triggering attempts.

18. The system of claim 17, wherein the one or more circuits are operable to select a portion of the second subset of adaptation incantations for modification based on one or more selection criteria, the selection criteria comprising non-use based parameters.

19. The system of claim 11, wherein the one or more circuits are operable to continue running the voice trigger after transitioning from the power-saving state, and wherein the voice trigger is configured to control the electronic device based on audio inputs, the controlling comprising:
comparing captured audio input with a plurality of other triggering commands; and
when there is a match between captured audio input and one of the plurality of other triggering commands, triggering one or more actions in the electronic devices that are associated with the one of the plurality of other triggering commands.

20. The system of claim 19, wherein the one or more circuits are operable to determine when there is match based on a plurality of adaptively configured state machines implemented by the voice trigger, each of which associate with one of the plurality of other triggering commands.

21. A system, comprising:
a microphone that is configured to capture audio signals;
a dedicated audio signal processing circuit that is configured for ultra-low-power consumption; and
wherein, when the electronic device is in a power-saving state:
the microphone obtains an audio input;
the dedicated audio signal processing circuit processes the audio input, to determine if the audio input corresponds to a preset triggering command; and
when the audio input corresponds to the triggering command, the dedicated audio signal processing circuit transitions the electronic device from the power-saving state.

22. The system of claim 21, wherein the dedicated audio signal processing circuit is configured to determine if the audio input corresponds to a preset triggering command based on an adaptively configured state machine that is implemented by the dedicated audio signal processing circuit.

23. The system of claim 22, wherein the adaptively configured state machine is based on a Hidden Markov Model (HMM).

24. The system of claim 22, wherein the adaptively configured state machine is configured as a two-dimensional state machine that comprises a plurality of lines of incantations, each of which corresponding to the preset triggering command.
